(19) United States
(12) Patent Application Publication
(10) Pub. No.: US 2005/0283554 A1
(43) Pub. Date: Dec. 22, 2005

(54) COMPUTER SYSTEM AND METHOD FOR QUEUING INTERRUPT MESSAGES IN A DEVICE COUPLED TO A PARALLEL COMMUNICATION BUS

(75) Inventors: Norman Davies, Barboursville, VA (US); Darrell Hatfield, Faber, VA (US); Frank Kattwinkel, Charlottesville, VA (US); Owen N. Wells, Waynesboro, VA (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/710,140

(22) Filed: Jun. 22, 2004

(51) Int. Cl. G06F 13/36

(52) U.S. Cl. 710/260

(57) ABSTRACT

A computer system and a method for queuing interrupt messages are provided. The computer system includes a parallel communication bus and a first device operably coupled to the parallel communication bus. The first device is configured to receive first and second interrupt messages transmitted through the parallel communication bus to a first bus address associated with the first device. The first and second interrupt messages each comprise a plurality of bits. The first device is configured to store the first and second interrupt messages in first and second memory locations, respectively, of a memory and to perform at least one task associated with the first interrupt message.

### BACKGROUND OF INVENTION

Computer systems have been developed that utilize a Peripheral Component Interconnect (PCI) bus. The PCI bus requires that exactly one PCI host device and one or more non-host PCI devices be operably coupled to the PCI bus. The PCI bus optionally includes a set of interrupt lines that are coupled between the PCI host device and the non-host PCI devices. Any non-host PCI device can change a voltage on an interrupt line to interrupt the PCI host device, causing the PCI host device to suspend whatever task it was performing and carry out a higher priority task associated with the interrupt.

During operation, a receiving device on a PCI bus that receives an interrupt signal generates one or more bus cycles to send a specific acknowledgement of the interrupt signal to the sending device. Thus, the receiving device can recognize only one interrupt signal between each interrupt acknowledgement. In a complex system, the amount of time for the receiving device to acknowledge an interrupt signal can become significant, and the acknowledgement time interval directly affects how quickly the sending device can send one interrupt signal after another. Thus, when two or more conditions occur in rapid succession where each warrant an interrupt signal, a relatively large time delay can occur in communicating the interrupt signals to the respective devices.

Thus, it would be desirable to have a parallel bus system that allows a receiving device to receive a plurality of interrupt messages where an acknowledgement is not transmitted for each interrupt message, but instead each message is stored in a memory queue upon receipt thereof.

### SUMMARY OF INVENTION

A computer system in accordance with an exemplary embodiment is provided. The computer system includes a parallel communication bus and a first device operably coupled to the parallel communication bus. The first device is configured to receive first and second interrupt messages transmitted through the parallel communication bus to a first bus address associated with the first device. The first and second interrupt messages each comprise a plurality of bits. The first device is configured to store the first and second interrupt messages in first and second memory locations, respectively of a memory and to perform at least one task associated with the first interrupt message.

A method for queuing interrupt messages in a first device operably coupled to a parallel communication bus in accordance with another exemplary embodiment is provided. The method includes receiving first and second interrupt messages transmitted through the parallel communication bus to a first bus address associated with the first device. The method further includes storing the first and second interrupt messages in first and second memory locations, respectively, of a memory associated with the first device. The first and second interrupt messages each comprise a plurality of bits. Finally, the method includes retrieving the first interrupt message from the first memory location and performing at least one task associated with the first interrupt message utilizing the first device.

An article of manufacture in accordance with another exemplary embodiment is provided. The article of manufacture includes a computer storage medium having a computer program encoded therein for queuing interrupt messages received through a parallel communication bus. The computer storage medium includes code for receiving first and second interrupt messages transmitted through the parallel communication bus. The computer storage medium further includes code for storing the first and second interrupt messages in first and second memory locations, respectively, of a memory. The first and second interrupt messages each comprise a plurality of bits. Finally, the computer storage medium includes code for retrieving the first interrupt message from the first memory location and performing at least one task associated with the first interrupt message.

Other systems and/or methods according to the embodiments will become or are apparent to one with skill in the art upon review of the following drawings and detailed description. It is intended that all such additional systems and methods be within the scope of the present invention, and be protected by the accompanying claims.

### BRIEF DESCRIPTION OF DRAWINGS

FIG. 1 is a schematic of a computer system in accordance with an exemplary embodiment;

FIG. 2 is a more detailed schematic of a portion of the computer system of FIG. 1;

FIGS. 3 and 4 are flowcharts of a method for queuing interrupt messages using the computer system of FIG. 1 in accordance with another exemplary embodiment.

### DETAILED DESCRIPTION

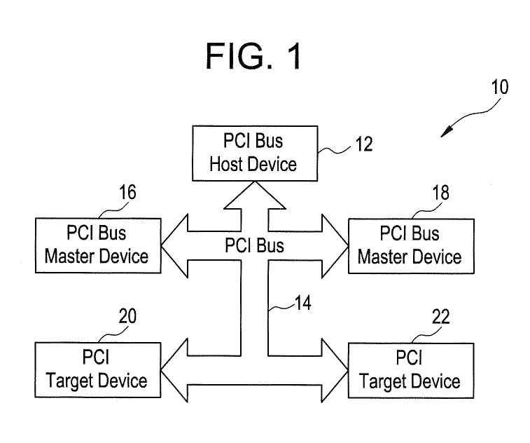

Referring to FIG. 1, a computer system 10 is provided.

As shown, the computer system 10 includes a PCI bus host device 12, a PCI bus 14, a PCI bus master device 16, a PCI bus master device 18, a PCI target device 20, and a PCI target device 22. An advantage of the computer system 10 is that the system 10 allows a device coupled to the parallel communication bus to queue multiple interrupt messages for performing tasks associated with the interrupt messages either immediately or at a future time. An interrupt signal or interrupt message induces a target device to temporarily suspend the other tasks of the target device, while the target device performs the tasks indicated by the interrupt message.

The PCI host device 12 is provided to perform tasks associated with facilitating communication through the PCI communication bus 14. The PCI host device 12 assigns a unique address range to each of the devices coupled to the PCI communication bus 14. Further, the PCI bus arbiter in the PCI host device 12 authorizes only one device coupled to the bus 14 to initiate a data transfer on the bus 14 at a specific time. In an alternate embodiment, the PCI bus arbiter can reside in a device other than the PCI host device 12.

The PCI bus 14 is provided to facilitate communication between the various devices attached to the bus 14. As shown, the bus 14 is operably coupled to the PCI bus host device 12, the PCI bus master device 16, the PCI bus master device 18, the PCI target device 20, and the PCI target device 22. It should be noted that in an alternate embodiment, the PCI communication bus 14 could be replaced with another type of bus, such as a VME bus for example.

The PCI bus master devices 16, 18 are provided to transmit PCI interrupt messages through the bus 14 to any device operably coupled to the bus 14. The PCI bus master device 16 comprises any device operably coupled to the bus 14 that has the ability to initiate a data transfer on the bus 14. For example, the PCI bus master device can be the PCI bus master device 16, the PCI bus master device 18, and the PCI host device 12. In particular, each of the PCI bus master devices 16 and 18 comprise a computer configured to transmit one or more PCI messages through the bus 14. Further, each of the devices 16 and 18 transmit an interrupt message by performing a bus write cycle through the bus 14 to a particular memory address that is assigned to the target device. Each interrupt message has a data portion with a plurality of bits that contain information that influences how the receiving device will react to the interrupt message. The information comprises one or more of the following: the identity of the sending device; the priority of the interrupt message; or the reason for the interrupt message. The target device 20 can comprise any of the devices operably coupled to the bus 14. For example, the PCI bus master device 16 can transmit interrupt messages to the PCI bus master device 18, the PCI target device 20, the PCI target device 22, and the PCI host device 12.

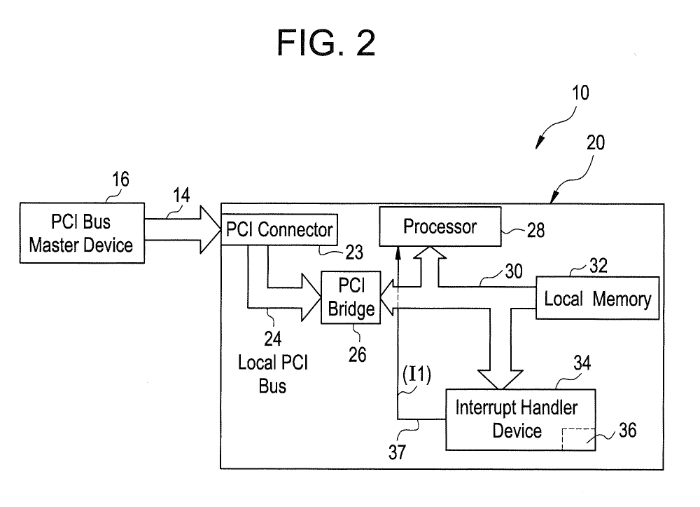

Referring to FIG. 2, a schematic of a portion of the computer system 10 is illustrated including the PCI bus master device 16 and the PCI target device 20.

The PCI target device 20 includes a PCI connector 23, a local PCI bus 24, a PCI bridge 26, a processor 28, a local memory bus 30, a memory 32, and an interrupt handler device 34. The PCI connector 23 is provided to operably couple the PCI target device 20 with the PCI communication bus 14. The local PCI bus 24 is operably coupled between the PCI connector 23 and the PCI bridge 26 and routes interrupt messages for the device 20 from the communication bus 14 to the PCI bridge 26. An advantage of the PCI target device 20 is that the target device 20 can queue a plurality of interrupt messages in memory 36 and thereafter execute a plurality of interrupt tasks responsive thereto.

The PCI communication bridge 26 is provided to transmit interrupt messages for device 20 through the local memory bus 30 to the interrupt handler device 34. In particular, when the PCI communication bridge 26 receives an interrupt message, the PCI communication bridge 26 performs a bus write cycle to a particular address that is assigned to the interrupt handler device 34. Thereafter, the interrupt handler device 34 writes the interrupt message to a predetermined address in the memory 36. In an alternate embodiment, the interrupt handler device 34 writes the interrupt message to a predetermined address in the memory 32. Further, in another alternate embodiment, the PCI communication bridge 26 can be embedded within the processor 28.

The processor 28 is provided to control communication through the bus 30 and to execute interrupt tasks (e.g., interrupt service request subroutines) in response to interrupt messages. The processor 28 is operably coupled to the bus 30 and is further coupled to the interrupt handler device 34. An interrupt communication line 37 is disposed between the processor 28 and the interrupt handler device 34. When the processor 28 receives an interrupt signal (I1) from the interrupt handler device 34, the processor 28 retrieves an interrupt message stored in memory 36 by the interrupt handler device 34. Thereafter, the processor 28 either: (i) executes a task associated with the interrupt message, or (ii) modifies process state variables such that the processor 28 will execute a task associated with the interrupt message at a future time. Thereafter, if there are more interrupt messages in the queue that have not been retrieved by the processor 28, the processor 28 continues to receive an interrupt signal from the interrupt handler device 34. In response to receiving the interrupt signal, processor 28 continues to retrieve interrupt messages from the queue and execute tasks associated with those interrupt messages until the queue becomes empty.

In an alternate embodiment, the interrupt handler device 34 sends another distinct interrupt signal to the processor 28 to indicate that an interrupt message is still pending. In yet another alternate embodiment, a protocol between processor 28 and the interrupt handler device 34 is defined such that the processor 28 determines if the interrupt queue is empty.

In still another alternate embodiment of the target device 20, a plurality of additional interrupt communication lines are disposed between the processor 28 and the interrupt handler device 34. Each interrupt communication line is configured to transmit a signal indicative of a distinct interrupt message. When the processor 28 receives a signal from the interrupt handler device 34 via an interrupt communication line, the processor 28 executes a task associated with that interrupt communication line. Thus, in this alternate embodiment, the processor 28 does not need to read the interrupt message from any device to determine which interrupt task to execute. Instead, the interrupt handler device 34 indicates the type of interrupt by transmitting a signal over a predetermined interrupt communication line of the plurality of interrupt communication lines to the processor 28.

The interrupt handler device 34 is operably coupled to the bus 30 and is configured to receive and store interrupt messages received from any PCI bus master device couple to the bus 14. As shown, the interrupt handler device 34 contains the internal memory device 36. In particular, the interrupt handler device 34 is configured to determine a memory address within the memory 36 for storing each interrupt message. Further, the device 34 is configured to transmit a signal (I1) to the processor 28 through the interrupt communication line 37 indicating that an interrupt message was received and stored within the memory 36. The interrupt handler device 34 comprises an application-specific integrated circuit (ASIC). In alternate embodiments, the interrupt handler device 34 can comprise a configurable programmable logic device (CPLD), a field programmable gate array (FPGA), a custom masked logic device, or other logical devices.

In an alternate embodiment, the interrupt handler device 34 does not have internal memory 36, but instead writes to a local memory 32 to store and retrieve interrupt messages. Thus, the interrupt handler device 34 writes to the local memory 32 to store the messages, and the processor 28 reads from the local memory 32 to retrieve interrupt messages.

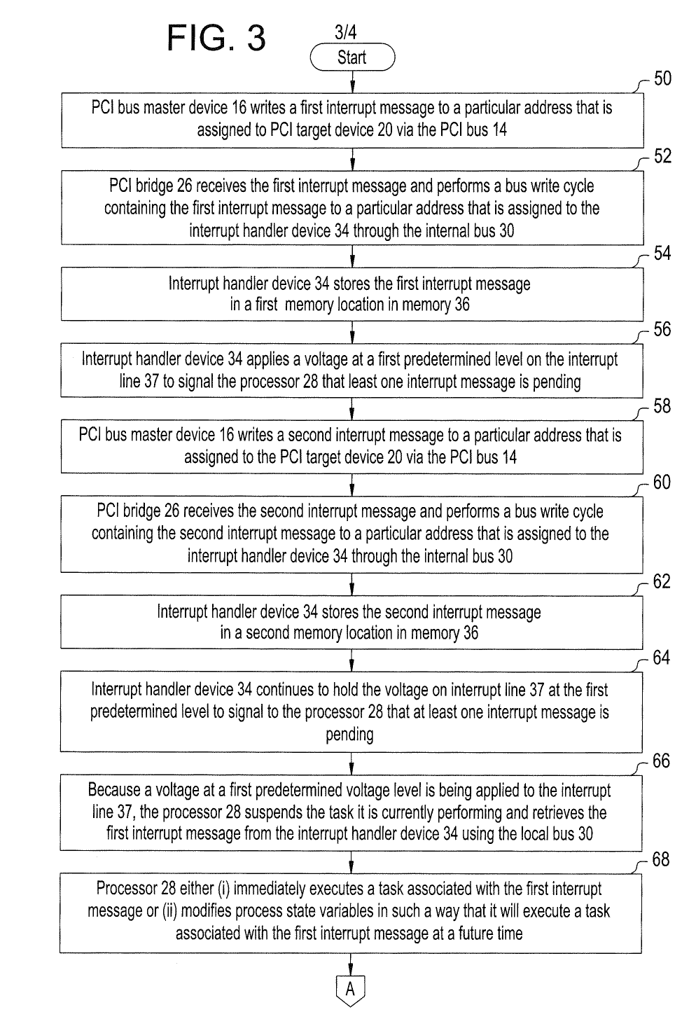

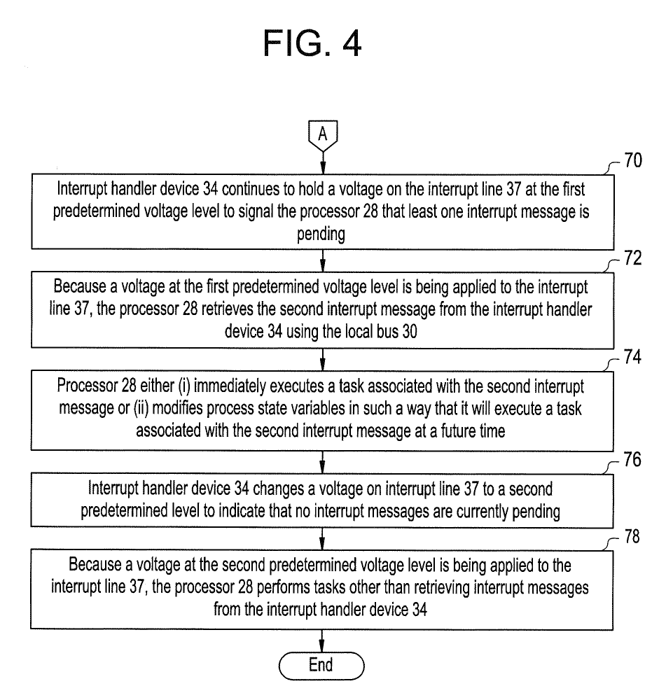

Referring now to FIGS. 3 and 4, a method for queuing multiple interrupt messages using the computer system 10 will be explained.

At step 50, the PCI bus master device 16 writes a first interrupt message to a particular address that is assigned to PCI target device 20, via the PCI bus 14.

At step 52, the PCI bridge 26 receives the first interrupt message and performs a bus write cycle containing the first interrupt message to a particular address that is assigned to the interrupt handler device 34 through the internal bus 30.

At step 54, the interrupt handler device 34 stores the first interrupt message in a first memory location of memory 36.

At step 56, the interrupt handler device 34 applies a voltage at a first predetermined level on the interrupt line 37 to signal the processor 28 that at least one interrupt message is pending.

At step 58, the PCI bus master device 16 writes a second interrupt message to a particular address that is assigned to the PCI target device 20 via the PCI bus 14.

At step 60, the PCI bridge 26 receives the second interrupt message and performs a bus write cycle containing the second interrupt message to a particular address that is assigned to the interrupt handler device 34 through the internal bus 30.

At step 62, the interrupt handler device 34 stores the second interrupt message in a second memory location of the memory 36.

At step 64, the interrupt handler device 34 continues to hold the voltage on interrupt line 37 at the first predetermined level to signal to the processor 28 that at least one interrupt message is pending.

At step 66, because a voltage at a first predetermined voltage level is being applied to the interrupt line 37, the processor 28 suspends the task it is currently performing and retrieves the first interrupt message from the interrupt handler device 34 using the local bus 30.

At step 68, the processor 28 either (i) immediately executes a task associated with the first interrupt message or (ii) modifies process state variables in such a way that it will execute a task associated with the first interrupt message at a future time.

At step 70, the interrupt handler device 34 continues to hold a voltage on the interrupt line 37 at the first predetermined voltage level to signal the processor 28 that at least one interrupt message is pending.

At step 72, because a voltage at the first predetermined voltage level is being applied to the interrupt line 37, the processor 28 retrieves the second interrupt message from the interrupt handler device 34 using the local bus 30.

At step 74, the processor 28 either (i) immediately executes a task associated with the second interrupt message or (ii) modifies process state variables in such a way that it will execute a task associated with the second interrupt message at a future time.

At step 76, the interrupt handler device 34 changes a voltage on interrupt line 37 to a second predetermined level to indicate that no interrupt messages are currently pending.

Finally, at step 78, because a voltage at the second predetermined voltage level is being applied to the interrupt line 37, the processor 28 performs tasks other than retrieving interrupt messages from the interrupt handler device 34.

The computer system and the method for queuing multiple interrupt messages provide a substantial advantage over other systems and methods. In particular, the system and method provide a technical effect of allowing a device coupled to parallel communication bus to queue multiple interrupt messages for performing tasks associated with the interrupt messages either immediately or at a future ti me.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and/or executed by a computer, the computer becomes an apparatus for practicing the invention. When implemented on a general-purpose microprocessor, the computer program code segments configure the microprocessor to create specific logic circuits.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

1. A computer system, comprising:
a parallel communication bus; and
a first device operably coupled to the parallel communication bus, the first device configured to receive first and second interrupt messages transmitted through the parallel communication bus to a first bus address associated with the first device, the first and second interrupt messages each comprising a plurality of bits, the first device configured to store the first and second interrupt messages in first and second memory locations, respectively, of a memory and to perform at least one task associated with the first interrupt message.

2. The computer system of claim 1, wherein the parallel communication bus comprises one of a PCI communication bus, a PCI-X communication bus, a CompactPCI communication bus, a VME communication bus, a VME64 communication bus, and a VME64x communication bus.

3. The computer system of claim 1, further comprising a second device operably coupled to the parallel communication bus, the second device configured to transmit the first and second interrupt messages through the parallel communication bus to the first device.

4. The computer system of claim 3, wherein the second device writes the first and second interrupt messages through the parallel communication bus to the first device.

5. The computer system of claim 1, further comprising second and third devices operably coupled to the parallel communication bus, the second device configured to transmit the first interrupt message through the communication bus to the first device, and the third device configured to transmit the second interrupt message through the communication bus to the first device.

6. The computer system of claim 5, wherein the second and third devices write the first and second interrupt messages, respectively, through the communication bus to the first device.

7. The computer system of claim 1, wherein the first interrupt message comprises an identifier identifying a device that transmitted the first interrupt message through the parallel communication bus to the first device.

8. The computer system of claim 1, wherein the first interrupt message comprises an interrupt command identifying a task for the first device to perform.

9. The computer system of claim 1, wherein the first device performs at least one task associated with the second interrupt message after retrieving the second interrupt message from the memory.

10. The computer system of claim 1, wherein the first interrupt message induces the first device to stop performing other tasks not associated with the first interrupt message.

11. The computer system of claim 1, wherein the first device comprises a bridge communication device, a processor, an interrupt handler device, and an internal bus operably coupled to the bridge communication device, the processor, and the interrupt handler device, the bridge communication device receiving the first interrupt message and transmitting the first interrupt message to the interrupt handler device.

12. The computer system of claim 11, wherein the interrupt handler device receives the first interrupt message and stores the first interrupt message in the memory, the interrupt handler device transmitting a first signal to the processor indicating that the first interrupt message has been stored in the memory, the processor retrieving the first interrupt message from the memory in response to the first signal.

13. The computer system of claim 12, wherein the processor performs at least one task associated with the first interrupt message after retrieving the first interrupt message.

14. The computer system of claim 11, wherein the interrupt handler device receives the first interrupt message and stores the first interrupt message in the memory, the interrupt handler device transmitting one of a plurality signals to the processor indicating the type of interrupt received, the processor retrieving the first interrupt message from the memory in response to the one of the plurality of signals.

15. The computer system of claim 14, wherein the processor performs at least one task associated with the first interrupt message after retrieving the first interrupt message.

16. A method for queuing interrupt messages in a first device operably coupled to a parallel communication bus, the method comprising:
receiving first and second interrupt messages transmitted through the parallel communication bus to a first bus address associated with the first device;
storing the first and second interrupt messages in first and second memory locations, respectively, of a memory associated with the first device, the first and second interrupt messages each comprising a plurality of bits; and
retrieving the first interrupt message from the first memory location and performing at least one task associated with the first interrupt message utilizing the first device.

17. The method of claim 16, wherein the parallel communication bus comprises one of a PCI communication bus, a PCI-X communication bus, a CompactPCI communication bus, a VME communication bus, a VME64 communication bus, and a VME64x communication bus.

18. The method of claim 16, further comprising:
writing the first interrupt message via a first write cycle to the first device through the parallel communication bus; and
writing the second interrupt message via a second write cycle to the first device through the parallel communication bus.

19. The method of claim 16, further comprising retrieving the second interrupt message from the memory and performing at least one task associated with the second interrupt message after retrieving the second interrupt message from the memory.

20. An article of manufacture, comprising:
a computer storage medium having a computer program encoded therein for queuing interrupt messages received through a parallel communication bus, the computer storage medium comprising:
code for receiving first and second interrupt messages transmitted through the parallel communication bus to a first bus address;
code for storing the first and second interrupt messages in first and second memory locations, respectively, of a memory, the first and second interrupt messages each comprising a plurality of bits; and
code for retrieving the first interrupt message from the first memory location and performing at least one task associated with the first interrupt message.

21. The article of manufacture of claim 20, wherein the parallel communication bus comprises one of a PCI communication bus, a PCI-X communication bus, a CompactPCI communication bus, a VME communication bus, a VME64 communication bus, and a VME64x communication bus.
